(19) United States
(12) Patent Application Publication
(10) Pub. No.: US 2004/0066031 A1
(43) Pub. Date: Apr. 8, 2004

(54) Cover with corner tabs

(75) Inventors: Galen C. Wong, South Pasadena, CA (US); Alice Chou, Walnut, CA (US); Christina Freeman, Ladera Ranch, CA (US)

Correspondence Address: OPPENHEIMER WOLFF & DONNELLY LLP, 840 NEWPORT CENTER DRIVE, SUITE 700, NEWPORT BEACH, CA, 92660, US

(73) Assignee: Avery Dennison Corporation

(21) Appl. No.: 10/266,530

(22) Filed: Oct. 7, 2002

(51) Int. Cl. B42D 3/00

(52) U.S. Cl. 281/31

(57) ABSTRACT

A folder having at least one document retaining tab for receiving and retaining at least one sheet of paper that has been inserted into a pocket of the folder. The document retaining tab may be provided as a center tab and/or as at least one interior corner tab of the folder. The folder may be formed from a single sheet of die-cut material that is folded along a plurality of score lines to form the folder and center or corner tabs. The die-cut sheet may be provided with extended portions that may be used to form the center or corner tabs. The extended portions may be mirror images of one another.

### FIELD OF THE INVENTION

The invention relates to a folder for receiving at least one sheet of paper, and more particularly, to a folder having a center or corner tab that receives and retains the paper inserted within the folder.

### BACKGROUND OF THE INVENTION

Folders are often used by students and others to store loose leaf papers, hand-outs, pamphlets, and other items. The folders typically store the papers within a pocket formed in an interior of the folder. The folders are often carried in back packs, brief cases, and the like. When the folders are used to store loose papers and carried in such carriers, the papers in the folder may fall out when the folder is inverted or shaken as it is carried. Additionally, if a folder is opened while unknowingly being inverted, the papers within the pockets of the folder may fall out.

### SUMMARY OF THE INVENTION

According to one embodiment, the invention relates to a folder having at least one tab. The folder may include a front cover and a back cover. The front cover and back cover may have a pocket formed therein for holding at least one sheet of paper or other material. The front cover and back cover may be provided with a center tab and/or corner tab(s) for receiving and holding a portion of the papers inserted within the pocket of the front cover and/or back cover. According to one embodiment of the invention, the folder is made from a single sheet of die-cut material. The material preferably includes a plurality of score lines that enable the material to be folded onto an interior portion of the front cover and back cover to form the folder, pockets, and center tab and/or corner tab(s).

The center and/or corner tab(s) enable a portion of the papers or other material stored in the folder to be inserted into an insert space of the tab. The tab may then be used to retain a portion of the papers such that the papers may not fall out of the folder should the folder be inverted.

### BRIEF DESCRIPTION OF THE DRAWINGS

FIG. 1 is a perspective view of a folder having a corner tab according to one embodiment of the invention.

FIG. 2 is an interior view of a folder having corner tabs according to one embodiment of the invention.

FIG. 3 is a top view of a sheet that has been die-cut to form a folder having corner tabs according to one embodiment of the invention.

FIG. 4 illustrates a corner tab of a folder that may receive at least one sheet of paper according to one embodiment of the invention.

FIG. 5 is a cross-sectional view of a corner tab of a folder according to one embodiment of the invention.

FIG. 6 is an interior view of a folder having a center tab according to one embodiment of the invention.

FIG. 7 is a top view of a die-cut sheet that may be used for forming a folder with a center tab according to one embodiment of the invention.

FIG. 8 is an interior view of a plastic folder having corner tabs according to one embodiment of the invention.

FIG. 9 is a cross-sectional view of a corner tab of a plastic folder according to one embodiment of the invention.

FIG. 10 is a cross-sectional view of a plastic folder having a corner tab according to one embodiment of the invention.

FIG. 11 is a top view of a die-cut sheet of plastic that may be used to form a folder having corner tabs according to one embodiment of the invention.

### DETAILED DESCRIPTION OF THE PREFERRED EMBODIMENTS

The invention relates to a document holder having a center tab and/or at least one corner tab. The document holder may be, for example, a folder, binder, portfolio or other device for holding documents.

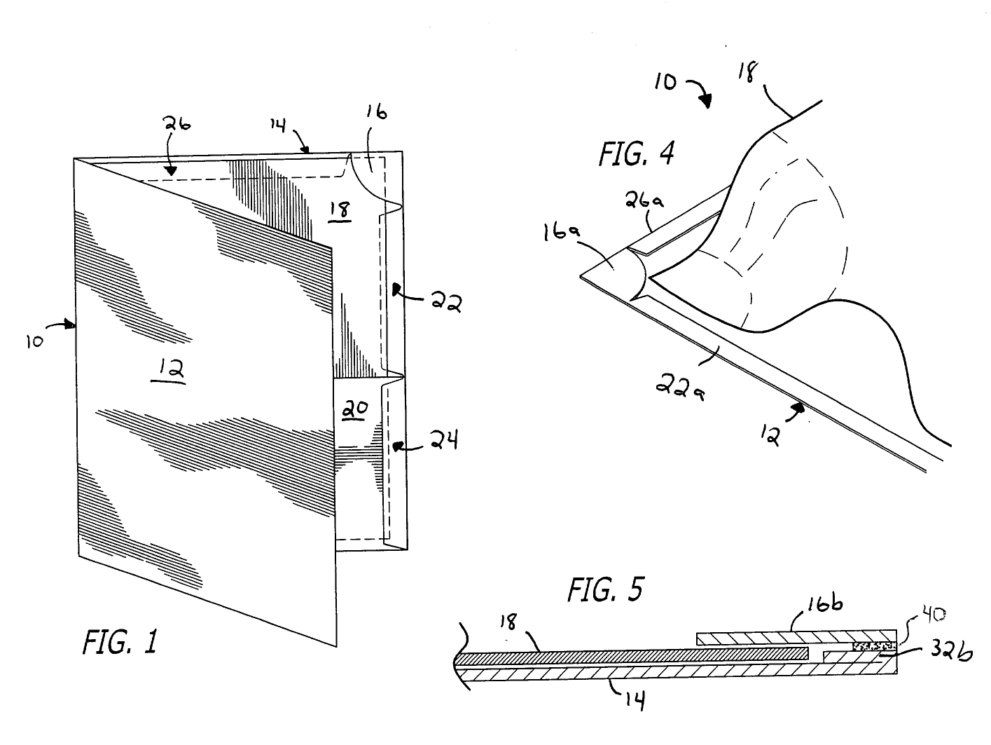

FIG. 1 is a perspective view of a folder 10 having a front cover 12 and a back cover 14. The folder 10 is preferably made from one sheet of die-cut material. The die-cut material may be, for example, light cardstock, a polymer or other known sheet material for forming a folder. The back cover 14 may be provided with a corner tab 16 for receiving and retaining at least one sheet of paper 18 or other material inserted in a pocket 20 formed on the back cover 14.

The back cover 14 may also include reinforcing members 22, 24, 26 for providing the back cover 14 with additional rigidity. The corner tab 16, pocket 20, and reinforcing members 22-26 may be formed from the back cover 14 by folding extended portions of the die-cut sheet along one or more score lines. According to one embodiment of the invention, the front cover 12 of the folder 10 may also be provided with a corner tab, pocket, and/or reinforcement members.

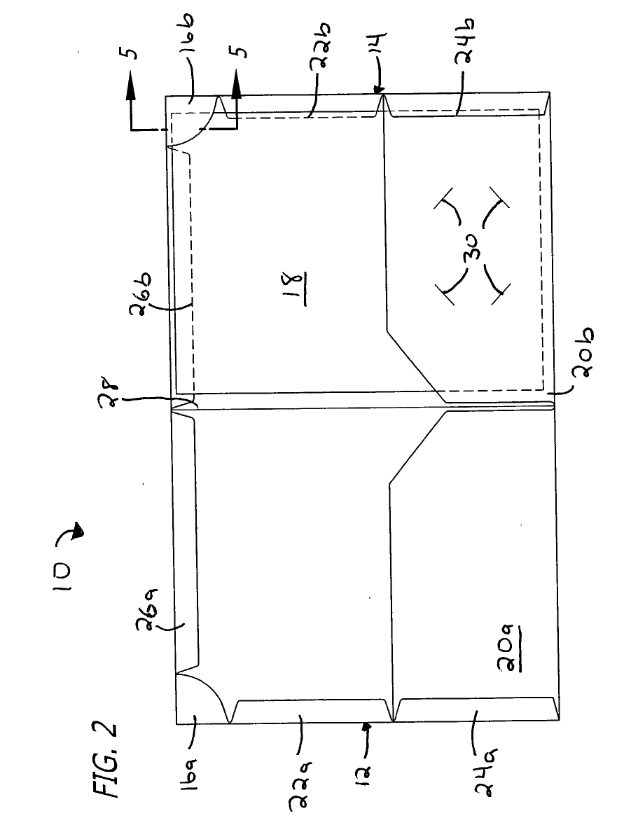

FIG. 2 illustrates an interior view of a folder 10 having a front cover 12 and a back cover 14. The folder 10 is preferably made from one sheet of die-cut material. The die-cut material may be, for example, light cardstock, a polymer or other known sheet material for forming a folder. The front cover 12 and back cover 14 may be folded on top of one another along a score line 28. The front cover 12 and back cover 14 may each include corner tabs 16A, 16B, respectively. The front cover 12 may have a pocket 20A and the back cover 14 may have a pocket 20B. The corner tabs 16A, 16B, may be used to receive and retain a corner portion of at least one sheet of paper 18 inserted in a respective pocket 20B. The corner tabs 16A, 16B may be used to prevent sheet(s) of paper or other material stored in the pockets 20A, 20B from inadvertently falling out of the folder 10. For example, if the folder 10 is inverted, the sheet(s) 18 may be retained within the folder 10 by the corner tabs 16A, 16B because the pockets 20A, 20B retain a bottom portion of the sheet(s) 18 and the corner tabs 16A, 16B retain at least part of a top portion of the sheet(s) 18. Therefore, the sheet(s) 18 are retained more securely in the pockets 20A, 20B.

The front cover 12 and back cover 14 may include optional reinforcing members 22A, 22B, 24A, 24B, 26A, 26B, respectively. The optional reinforcing members 22A, 22B, 24A, 24B, 26A, 26B may be formed by folding extended portions of the die-cut sheet of material along one or more score lines. The optional reinforcing members 22A, 22B, 24A, 24B, 26A, 26B may be secured to an interior side of the front cover 12 and back cover 14 by, for example, glue, welds, or other known securing mechanisms.

The back cover 14 may include die-cuts 30 that are configured to form a business card holder as is known in the art. Alternatively, the die-cuts 30 may be placed on the front cover 12, both the front cover 12 and back cover 14, or neither.

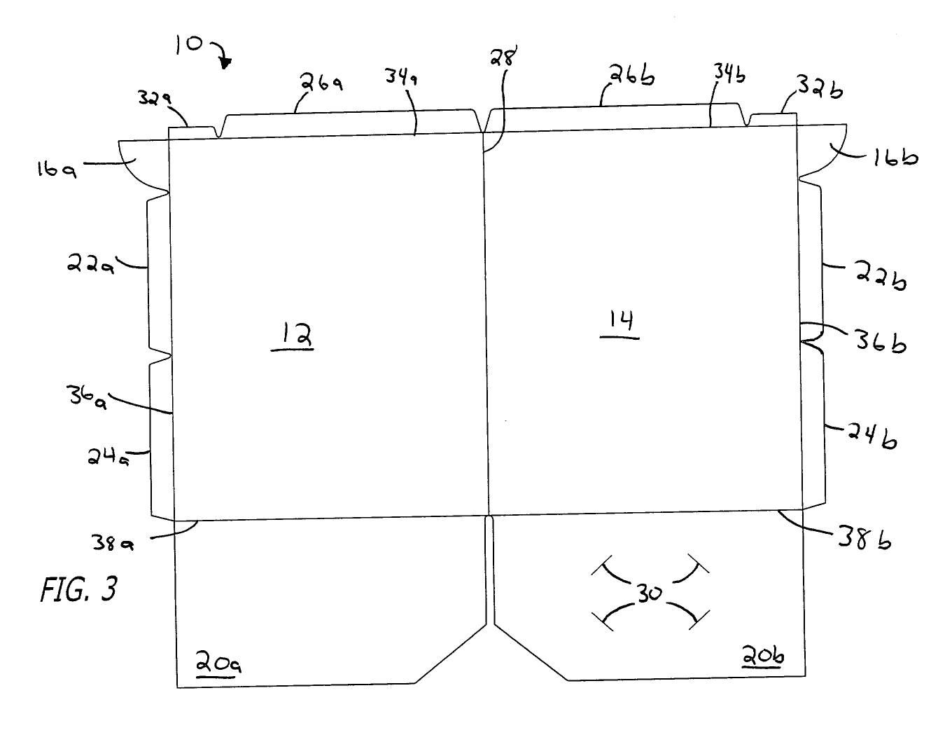

FIG. 3 is a top view of a sheet 10 that may be used to form a folder having corner tabs. The sheet 10 is preferably made from a single die-cut sheet of material. The material used for sheet 10 may be, for example, light cardstock, a polymer, or other known sheet material for making folders. The sheet 10 preferably includes a front cover 12 and back cover 14. The front cover 12 and back cover 14 may be folded on top of each other along a score line or fold line 28. The front cover 12 and back cover 14 may also include corner tabs 16A, 16B, respectively. The corner tabs 16A, 16B may be formed by extended portions of the front cover 12 and back cover 14. The extended portions may be folded along fold lines 36A, 36B, respectively, provided on the die-cut sheet 10. The extended portions used to form the corner tabs 16A, 16B may be, for example, mirror images of a quarter circle extending from an upper corner of the front cover 12 and back cover 14. The corner tabs 16A, 16B may be used to receive and retain a portion of at least one sheet of paper inserted into pockets 20A, 20B formed on the front cover 12 and back cover 14. The pockets 20A, 20B may be formed by extended portions located along bottom portions of the front cover 12 and back cover 14. The pockets 20A, 20B may be folded on top of an interior portion of the front cover 12 and back cover 14, respectively, along fold lines 38A, 38B.

According to another embodiment of the invention, the corner tabs 16A, 16B may be formed from a separate piece of material. The corner tabs 16A, 16B may include a separate piece of material that is glued, welded, riveted or otherwise attached to the front cover 12 and back cover 14. The corner tabs 16A, 16B may include score lines that enable the corner tabs 16A, 16B to be folded onto an interior portion of the front cover 12 and back cover 14.

The front cover 12 and back cover 14 may also include members 22A, 22B, 24A, 24B, 26A, 26B, respectively, which may be extended portions of the die-cut sheet 10 along a top and/or side of the front cover 12 and back cover 14. The members 22A, 22B, 24A, 24B, 26A, and 26B provided on the sides of the front cover 12 and back cover 14 may be mirror images of a half of a hexagon, or any other suitable shape. The reinforcing members 22A-26B may be formed by folding the extended portions of the sheet 10 onto an interior portion of the front cover 12 and back cover 14 along fold lines 34A, 34B, 36A, 36B. The members 22A, 22B, 24A, 24B, 26A, and 26B may be used to provide additional support or rigidity to a folder formed from sheet 10. The members 24A, 24B may serve to secure the respective pockets 20A, 20B. The corner tabs 16A, 16B, pockets 20A, 20B, and members 22A, 22B, 24A, 24B, 26A, and 26B may be folded onto the interior of the respective covers. Members 24A and 24B may fold atop pocket portions 20A and 20B. Members 22A, 22B, 26A, and 26B fold onto the interior portions of the front cover and back cover 12, 14, respectively. A permanent adhesive or glue may be used to secure the interior of the pocket in place. The corner tabs 16A, 16B, once secured into place using, for example, members 32A, 32B, provide an insert space for receiving and returning at least one sheet of paper. Accordingly, the insert space is sufficient to accommodate the width of at least one sheet of paper.

The pocket 20B may be provided with a plurality of die-cuts 30 that are configured to form a business card holder as is known in the art. According to one embodiment of the invention, the pocket 20A may also be provided with die-cuts that form a business card holder. According to other embodiments, the die-cuts 30 may be provided on both the front and back pocket(s) 20A & 20B or neither.

FIG. 4 illustrates a sheet of paper 18 that may be inserted beneath a corner tab 16A of a folder 10. The corner tab 16A may form an insert space between the corner tab 16A and an interior portion of a front cover 12 having members 22A, 26A of the folder 10. Preferably, the insert space is of a width that is sufficient to receive at least one sheet of paper.

FIG. 5 is a cross-sectional view of a corner tab 16B. The corner tab 16B may be formed by folding an extended top portion 32B of a back cover 14 onto an interior side of the back cover 14. An extended side portion of the back cover 14 may then be folded onto the interior side of the back cover 14. The corner tab 16B and top portion 32B may then be secured to each other by welding, gluing or other known securing mechanism 40. The corner tab 16B and top portion 32B are preferably configured such that an interior space is formed between the corner tab 16B and the back cover 14. The insert space preferably enables at least one sheet of paper 18 to be inserted therein.

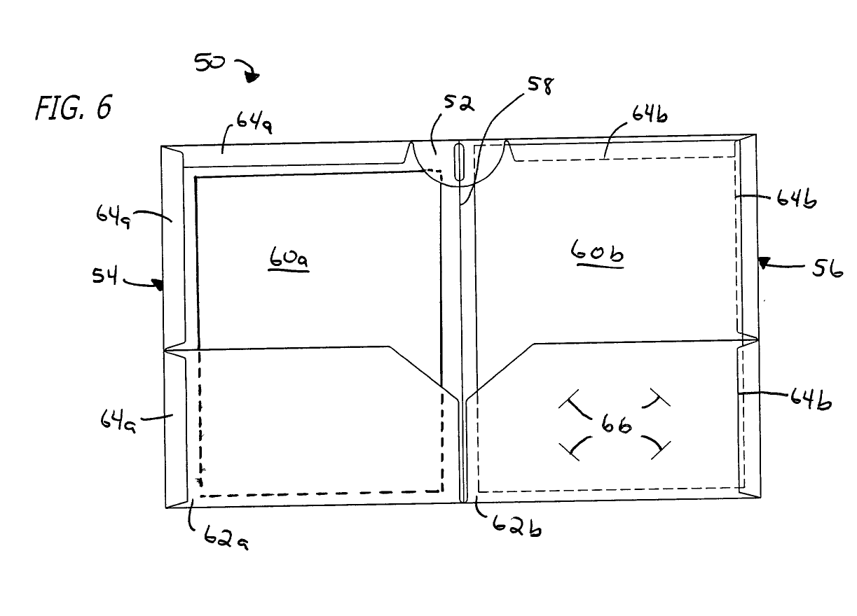

FIG. 6 is an interior view of a folder 50 having a center tab 52. The folder 50 may include a front cover 54 and back cover 56. The front cover 54 and back cover 56 may be provided on opposite sides of a score line 58. The center tab 52 forms two corner tabs, one at each central corner of the folder 50. The central corners are those that are immediately on either side of the score line 58. At least one sheet of paper 60A, 60B may be inserted into a pocket 62A or 62B formed from the front cover 54 or back cover 56, respectively. In FIG. 6, two sheets of paper 60A and 60B are inserted into each pocket 62A, 62B of the folder 50, respectively. An inner upper corner of the sheets 60A, 60B may be inserted beneath and retained by the center tab 52. The center tab 52 may be used to prevent the sheets 60A, 60B from inadvertently falling out of one of the pockets 62A, 62B. The center tab 52 may be formed by folding an extended portion of a top portion of the front cover 54 and back cover 56.

The center tab 52 is illustrated in FIG. 6 as a single piece. However, the center tab 52 may alternatively be two separate pieces as, for example, if the center tab 52 is cut into two. As a further alternative, the embodiment of FIG. 6 may include outer corner tabs as shown in FIG. 2, for example.

The folder 50 may also include reinforcing members 64A, 64B. The reinforcing members 64A, 64B may provide additional support for the folder 50. The folder 50 may also include a plurality of die-cuts 66 that form a business card holder as is known in the art. The die-cuts 66 may be formed in one, both, or neither of the pockets 62A, 62B.

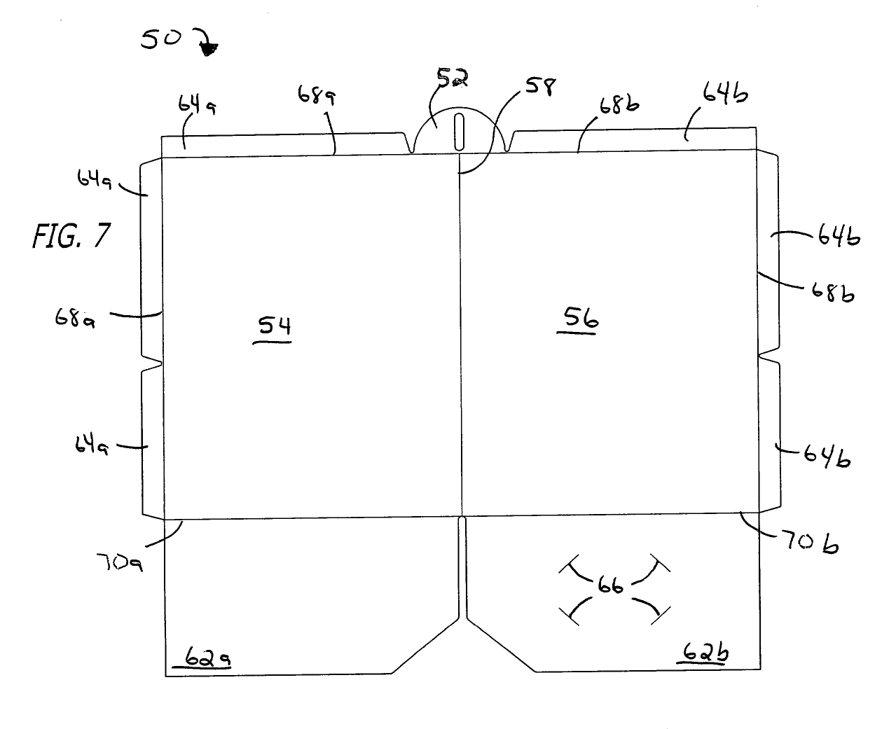

FIG. 7 illustrates a single sheet of material 50 that has been die-cut and provided with a plurality of score lines to form a folder having a center tab 52. The material may be, for example, light card stock, a polymer or other known material for making folders. The sheet 50 preferably includes a front cover 54 and a back cover 56. The front cover 54 and back cover 56 may have a score line 58 provided therebetween. A center tab 52 may be extended portions of the front cover 54 and back cover 56 located along top side thereof. The extended portions may be mirror images of a quarter circle provided on each side of the score line 58. The center tab 52 may be formed by folding the extended portions along fold lines 68A, 68B formed in the front cover 54 and back cover 56, respectively. The center tab 52 may be used to retain an upper corner portion of at least one sheet of paper that may be inserted in a pocket 62A of the front cover 54 or a pocket 62B of the back cover 56. The pockets 62A, 62B may be formed by folding extended bottom portions of the front cover 54 and back cover 56 along a bottom score line 70A, 70B formed in the sheet 50.

According to another embodiment of the invention, the center tab 52 may be formed from a separate piece of material. The center tab 52 may include a separate piece of material that is glued, welded, riveted or otherwise attached to the front cover 54 and back cover 56. The center tab 52 may include a score line that enables the center tab 52 to be folded onto an interior portion of the front cover 54 and back cover 56.

The sheet 50 may also include a plurality of reinforcing members 64A, 64B. The optional reinforcing members 64A, 64B may be made from portions of the sheet 50 extending partially beyond a top and side of the front cover 54 and back cover 56. The optional reinforcing members 64A, 64B may be formed by folding the extended portions of the front cover 54 and back cover 56 along at least one of a top score line 68A, or side score line 68B provided in the sheet 50. At least one of the pockets 62A, 62B may be provided with die-cuts 66 that are configured to form a business card holder as is known in the art.

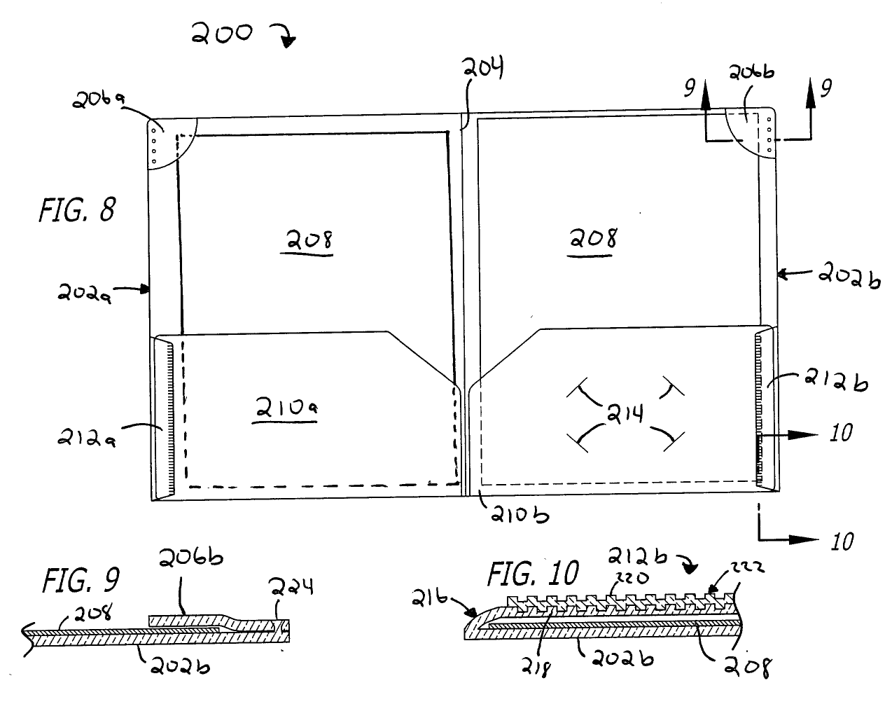

FIG. 8 illustrates an interior view of a plastic folder 200 according to one embodiment of the invention. The folder 200 is preferably formed from a single die-cut sheet of plastic. The folder 200 includes a front cover 202A and back cover 202B. The front cover 202A and back cover 202B may be distinguished by a substantially center score line 204. The front cover 202A and back cover 202B may include interior corner tabs 206A, 206B, respectively. The interior corner tabs 206A, 206B may be used to receive and retain, for example, at least one sheet of paper 208. The corner tabs 206A, 206B may be used to prevent the sheet of paper 208 from inadvertently falling out of a pocket 210A, 210B formed on the front cover 202A and back cover 202B, respectively.

The front cover 202A and back cover 202B may also include reinforcing members 212A, 212B, respectively. The reinforcing members 212A, 212B may be used to form a portion of the pockets 210A, 210B formed in an interior of the front cover 202A and back cover 202B.

Die-cuts 214 may be provided in at least one of the pockets 210A, 210B of the front cover 202A and back cover 202B. The die-cuts 214 may be arranged to form a business card holder as is known in the art.

FIG. 9 is a cross-sectional view of a plastic interior corner tab 206B according to one embodiment of the invention. The interior corner tab 206B may be formed by folding an extended portion of a die-cut sheet onto an interior portion of a back cover 202B. An attachment mechanism 224 may be used to retain the extended portion on the back cover 202B. The attachment mechanism may be, for example, a rivet, glue, or weld. The extended portion is preferably folded over the back cover 202B to form an insert space between the interior corner tab 206B and back cover 202B. The insert space may be used to receive at least one sheet of paper 208 that may be inserted into a pocket of a folder according to one embodiment of the invention. The extended portion enables the sheet 208 to remain in the pocket in the event that the folder is inadvertently inverted.

FIG. 10 illustrates a cross-section of an optional reinforcing member 212b according to one embodiment of the invention. The reinforcing member 212B may be formed by folding an extended portion 216 of a back cover 202B onto an interior portion of the back cover 202B. The extended portion may include a weld line where the assembly has been heat welded. A plurality of locking members 218 may be used to interlock with a plurality of locking members 220 provided on a pocket 222 of a folder. The members 218, 220 may be used to secure the portion 216 to the pocket 222. The extended portion 216 is folded and secured to the pocket 222 such that the pocket 222 may receive at least one sheet of paper 208. The extended portion 216 may be secured to the pocket 222 by gluing, welding, riveting or other known securing method. Interlocking portions 218, 220 represent a weld pattern, for example.

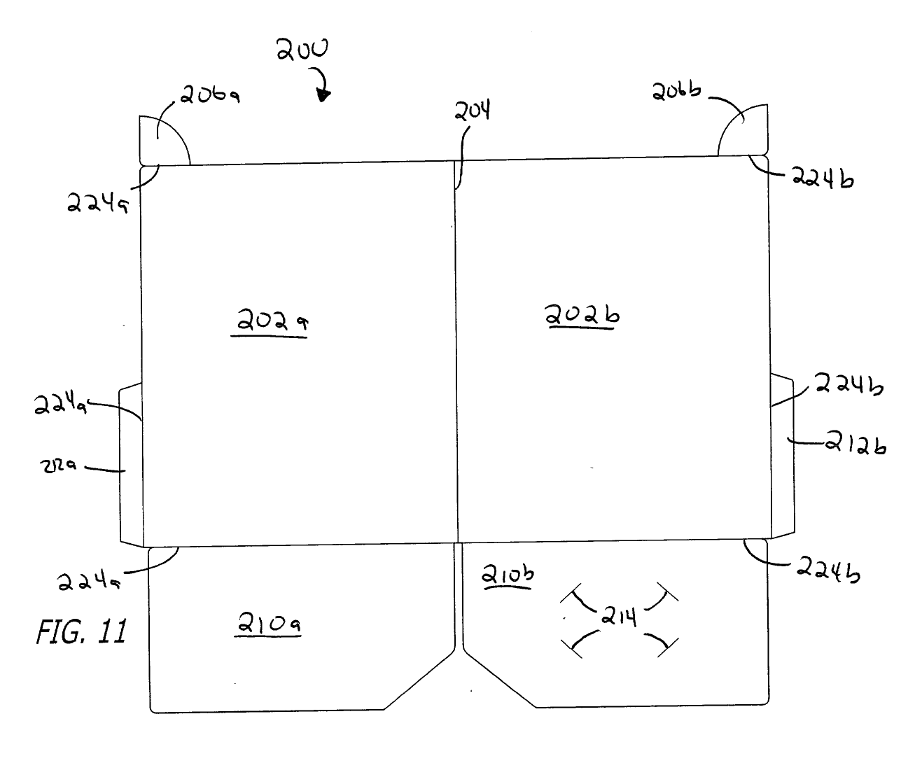

FIG. 11 is a top view of a single sheet 200 of die-cut plastic that may be used to form a folder having interior corner tabs 206A, 206B. The sheet 200 may include a front cover 202A and back cover 202B. The interior corner tabs 206A, 206B may be portions of the sheet 200 that are extended beyond a side of a front cover 202A and back cover 202B. The interior corner tabs 206A, 206B may be folded along a score line 224A, 224B to create an insert space between the interior corner tabs 206A, 206B and the front cover 202A and back cover 202B. The sheet 200 may be divided along a score line 204 to form the front cover 202A and back 202B. The front cover 202A and back cover 202B may be provided with a plurality of score lines 224A, 224B. At least one of the score lines 224A, 224B may be provided along a side portion side of the front cover 202A and back cover 202B to form reinforcing member 212A, 212B formed by an extended portion of the die-cut sheet 200. At least one lower score line 224A, 224B may be used to form a pocket 210A, 210B formed on an interior of the front cover 202A and back cover 202B, respectively. The pocket 210B may include die-cuts 214 that are configured to form a business card holder as is known in the art. It should be understood that the die-cuts 214 may be provided on either, both, or neither of the pockets 210A, 210B.

According to another embodiment of the invention, the corner tabs 206A, 206B may be formed from a separate piece of material. The corner tabs 206A, 206B may include a separate piece of material that is glued, welded, riveted or otherwise attached to the front cover 202A and back cover 202B. The corner tabs 206A, 206B may include score lines that enable the corner tabs 206A, 206B to be folded onto an interior portion of the front cover 202A and back cover 202B

While the specification describes particular embodiments of the present invention, those of ordinary skill can devise variations of the present invention without departing from the inventive concept.

We claim:

1. A document holder comprising:
a first cover and a second cover joined together;
each of said first cover and said second cover having an inner surface on the interior of the document holder and an outer surface on the exterior of the document holder;
each of said first cover and said second cover having an upper corner;
a retention pocket in the interior of at least the first cover;
a first corner tab on an upper corner of the first cover, said corner tab adapted to receive and retain a portion of a document stored in the document holder;
wherein a document may be stored within the retention pocket and at least partially retained within the corner tab.

2. A document holder as defined in claim 1, wherein the interior of said first cover includes an upper outer corner and an upper central corner, said corner tab being on said upper outer corner.

3. A document holder as defined in claim 1, wherein the interior of said first cover includes an upper outer corner and an upper central corner, said corner tab being on said upper central corner.

4. A document holder as defined in claim 1, wherein said first cover and said second cover each include respective upper outer corners and upper central corners, said second cover comprising a second corner tab on an upper corner thereof.

5. A document holder as defined in claim 4, wherein said first and second corner tabs are on said upper central corners of said first and second covers.

6. A document holder as defined in claim 4, wherein said first and second corner tabs are on said upper outer corners of said first and second covers.

7. A document as defined in claim 4, wherein at least one of said first cover and said second cover includes two corner tabs, one corner tab on an upper outercorner thereof and another corner tab an upper central corner thereof.
Broad Independent claim

8. A sheet-retaining document holder having a corner tab comprising:
a front cover having an exterior and an interior;
a back cover interconnected with said front cover, said back cover having an exterior and an interior;
a pocket on at least one of the front cover and the back cover;
a corner tab on the interior of at least one of the front cover and the back cover, said corner tab providing at least one insert space for a corner of a sheet.
One-Piece Construction

9. A document holder as described in claim 8, wherein said front cover, back cover, and corner tab are unitarily formed from a single sheet of material.
Separate Corner Tab

10. A document holder as described in claim 8, wherein the corner tab is initially separate from said front cover and back cover, and is then attached to one of said front cover and said back cover.

11. A document holder as described in claim 8, wherein the corner tab is attached by welding or gluing.
Two-Piece Cover

12. A document holder as described in claim 8, wherein the front cover and back cover comprise separate sheets of material attached together.
Folder

13. A document holder as described in claim 8, wherein the document holder is a folder having corner tabs in upper corners of said document holder.

14. A document holder as described in claim 13, wherein the front cover, back cover, and corner tabs are unitarily formed from the same sheet of material.

15. A document holder as described in claim 13, wherein the corner tabs are initially separate from said front and back covers and are attached thereto.

16. A document holder as described in claim 13, wherein the document holder comprises reinforcement members along edges thereof.

17. A document holder having a corner tab comprising:
a front cover having an exterior and an interior;
a back cover interconnected with said front cover, said back cover having an exterior and an interior;
a pocket on at least one of the front cover and the back cover;
a corner tab on the interior of at least one of the front cover and the back cover, said corner tab providing at least one insert space;
said front cover, back cover, and corner tab being formed from a single sheet of material.

18. The document holder as defined in claim 17, wherein the single sheet of material is light cardstock.

19. The document holder as defined in claim 17, wherein the single sheet of material is a polymer.

20. The document holder as defined in claim 17, wherein the single sheet is folded and portions thereof secured to other portions thereof, to form a document holder.

21. The document holder as defined in claim 17, wherein said pocket comprises a pocket flap that is secured to the interior of said at least one of the front cover and the back cover.

22. The document holder as defined in claim 17, wherein said insert space is sufficient to accommodate the width of a sheet of paper.

23. The document holder as defined in claim 17, wherein said at least one corner tab is in a outer corner of said document holder.

24. The document holder as defined in claim 17, wherein said at least one corner tab is in a central corner of said document holder.

25. The document holder as defined in claim 17, wherein the document holder further comprises reinforcing portions along edges thereof.

26. The document holder as defined in claim 17, wherein document holder is at least one of a folder or a binder.

27. A document holder comprising:
a front cover and a back cover each having an interior and an exterior;
an interior pocket on said front cover and an interior pocket on said back cover;
a first document-retaining corner tab on an upper corner of the front cover and a second document-retaining corner tab on an upper corner of the back cover;
said front cover, back cover, interior pockets and corner tabs all being formed from a single sheet of material.

28. The document holder as defined in claim 27, wherein said first upper corner is an outer corner.

29. The document holder as defined in claim 27, wherein said first upper corner is an central corner.

30. The document holder as defined in claim 27, wherein said first document-retaining corner tab is on an interior corner of the front cover and said second document-retaining corner is on an interior corner of the back cover.

31. The document holder as defined in claim 27, wherein said first and second corner tabs are formed from a unitary, central corner tab piece.
